(19) United States
(12) Patent Application Publication
(10) Pub. No.: US 2024/0015849 A1
(43) Pub. Date: Jan. 11, 2024

(54) LOSSLESS SWITCHING BETWEEN PTP AND PTM TRANSMISSION AND RECEPTION IN MBS

(71) Applicant: InterDigital Patent Holdings, Inc., Wilmington, DE (US)

(72) Inventors: Oumer Teyeb, Montreal (CA); Yugeswar Deenoo Narayanan Thangaraj, Chalfont, PA (US)

(73) Assignee: InterDigital Patent Holdings, Inc., Wilmington, DE (US)

(21) Appl. No.: 18/271,079

(22) PCT Filed: Jan. 11, 2022
(86) PCT No.: PCT/US2022/011941

§ 371 Date: Jul. 6, 2023

Related U.S. Application Data
(60) Provisional application No. 63/135,930, filed on Jan. 11, 2021.

(51) Int. Cl. H04W 76/40; H04W 76/20

(52) U.S. Cl. CPC H04W 76/40; H04W 76/20; H04W 88/06

(57) ABSTRACT

A wireless transmit-receive unit (WTRU) may receive an indication to switch from a point-to-point (FTP) transmission mode to a point-to-multipoint (PTM) transmission mode or determine to switch from the PTP transmission mode to the PTM transmission mode based on a reliability condition associated with the PTM mode. Based on the indication or the determination, the WTRU may switch from the PTP transmission mode to the PTM transmission mode. The WTRU may receive a first data packet. The WTRU may extend a data packet reception window by extending a boundary of the data packet reception window. The boundary may be extended based on a sequence number (SN) of the first data packet and an offset.

### CROSS-REFERENCE TO RELATED APPLICATIONS

This application claims the benefit of Provisional U.S. Patent Application No. 63/135,930, filed Jan. 11, 2021, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein associated with lossless switching between point-to-point (PTP) and point-to-multipoint (PTM) transmission and reception, e.g., in multicast and broadcast services (MBS). A wireless transmit-receive unit (WTRU) may receive an indication to switch from using point-to-point (PTP) transmission (e.g., from a PTP transmission mode) to using point-to-multipoint (PTM) transmission (e.g., to a PTM transmission mode) or determine to switch from using PTP transmission (e.g., from the PTP transmission mode) to using PTM transmission (e.g., to the PTM transmission mode) based on a reliability condition associated with the PTM mode. Based on the indication or the determination, the WTRU may switch from using PTP transmission (e.g., from the PTP transmission mode) to using PTM transmission (e.g., to the PTM transmission mode). The WTRU may receive a first data packet. The WTRU may extend a data packet reception window by extending a boundary of the data packet reception window. The boundary may be extended based on a sequence number (SN) of the first data packet and an offset. In some examples, the WTRU may receive a second data packet and add the second data packet to a reception buffer for processing and the addition may be based on a second SN of the second data packet being within an extended part of the extended data packet reception window. In some examples, the boundary of the data packet reception window may be a starting edge of the data packet reception window and extending the boundary of the data packet reception window may include setting a first value of the starting edge to a second value that is lower than the SN of the first data packet by the offset. In some examples, the extended part of the extended data packet reception window may be a part of the extended data packet reception window that starts at the second value and ends at the SN of the first data packet.

A WTRU may receive a first data packet. The WTRU may determine to switch from using PTM transmission (e.g., from a PTM transmission mode) to using PTP transmission (e.g., to a PTP transmission mode) based on a reliability condition associated with the PTM transmission mode. Based on the determination, the WTRU may send a request to switch from using PTM transmission (e.g., from the PTM transmission mode) to using PTP transmission (e.g., to the PTP transmission mode). The WTRU may receive an indication to switch from using PTM transmission (e.g., from the PTM transmission mode) to using PTP transmission (e.g., to the PTP transmission mode). Based on the indication, the WTRU may switch from using PTM transmission (e.g., from the PTM transmission mode) to using PTP transmission (e.g., to the PTP transmission mode) and may send a data packet status report. The data packet status report may indicate the first data packet was received.

A WTRU may, as shown by example in FIG. 3, trigger an MBS mode switch(es) (e.g., based on an indication, such as an indication received from the network, or, based on a determination by the WTRU). A WTRU (e.g., see 304 in FIG. 3) may be configured for MBS and may be configured with one or more Multicast Radio Bearers (MRBs) (e.g., see 308 in FIG. 3). The WTRU may receive configuration information from the network (e.g., see 306 in FIG. 3), which may include parameters/thresholds (e.g., to be used) for triggering MBS mode switching. The parameters/thresholds may include signal levels/thresholds concerning a serving cell (e.g., reference signal received power (RSRP) level(s)/threshold(s), reference signal received quality (RSRQ) level(s)/threshold(s), received signal to noise indicator (RSNI) level(s)/threshold(s), and/or the like), HARQ failure/success rate(s) level(s)/threshold(s), retransmission count(s) of the MRB(s) level(s)/threshold(s), etc. The WTRU may monitor performance of the MBS operation (e.g., according to the configuration information or a WTRU implementation). The WTRU may determine to switch the MBS mode. For example, the WTRU (e.g., if operating in a PTM mode) may determine to switch to a PTP mode, e.g., if the signal level of the serving cell falls below a threshold and/or if a HARQ failure rate/retransmission count is above a threshold (e.g., see 310 in FIG. 3). The WTRU may send an MBS mode switch request when determining to switch MBS mode, for example, from PTM to PTP, or vice versa (e.g., see 312 in FIG. 3). The request may include information, such as a packet data convergence protocol (PDCP)/RLC receive status report, MRBs affected (e.g., MRB(s) associated with the mode the WTRU requests to switch to), etc. A PDCP/RLC receive status report may be sent, e.g., separately from the request (e.g., see 314 in FIG. 3). The WTRU may receive an indication from the network (e.g., see 306 in FIG. 3) to switch from PTM to PTP (e.g., at 313 in response to 312, as shown in FIG. 3). A WTRU may change PDCCH transmission monitoring behavior (e.g., monitor for a C-RNTI only, monitor for a G-RNTI only, or monitor for both the C-RNTI and G-RNTI), for example, before/during/after sending the MBS mode switch request.

In examples, a WTRU (e.g., see 304 in FIG. 3) may switch (e.g., implicitly switch) an MBS mode (e.g., perform an implicit MBS mode switch). A WTRU may be configured for MBS and may be configured with one or more MRBs. The WTRU may receive configuration information from the network (e.g., see 306 in FIG. 3) specifying the WTRU behavior, e.g., for the case that the WTRU is operating in a PTP mode and an RLC PDU is received, e.g., where the RLC PDU is associated with a PTM mode, e.g., with an associated RLC entity being associated with a PTM mode. The WTRU (e.g., if operating in the PTP mode) may receive an RLC PDU (e.g., a trigger PTM RLC PDU, for example, an RLC PDU that triggers a switch to PTM), e.g., where the RLC PDU is associated with a PTM mode, e.g., with the associated RLC entity being associated with the PTM. The WTRU may (e.g., based on the configuration information) determine (e.g., consider) the reception of the RLC PDU as an implicit MBS mode switch request from the network (e.g., see 319 in FIG. 3). The WTRU may start a time period (e.g., a timer). The value of the time period (e.g., the timer) may be specified in the received configuration information. The WTRU may (e.g., during the time period (e.g., while the timer is running)) operate the PTM RLC entity in a mode (e.g., a special (e.g., RLC) mode). The special RLC mode may be or may implement one or more of the following (e.g., as may be indicated in the received configuration information or may be otherwise configured): refrain from discarding PDUs with a sequence number (SN) lower than an SN of the trigger PTM RLC PDU and forward the PDUs to a PDCP layer; extend a RLC window size by decrementing a receive RLC window left edge by an offset (e.g., a determined, selected, or configured offset, such as half of the receive RLC window size) (e.g., see 320 in FIG. 3); extend the RLC window size by incrementing the receive RLC window right edge by an offset (e.g., a determined, selected, or configured offset, such as half of the receive RLC window size); operate the RLC in a windowless or transparent RLC like mode, for example, by forwarding received PDUs (e.g., all received PDUs) to a PDCP layer; or operate the PTM RLC entity in a UM mode (e.g., a normal UM mode), for example, if the time period elapses (e.g., the timer expires).

In examples, a WTRU (e.g., see 304 in FIG. 3) may switch (e.g., explicitly switch) an MBS mode (e.g., perform an explicit MBS mode switch). A WTRU may be configured for MBS and may be configured with one or more MRBs. The WTRU may receive a command from the network (e.g., an RRC reconfiguration, a MAC CE, a DCI, and/or the like) (e.g., see 313 and 319 in FIG. 3). The command may indicate (e.g., specify) that the WTRU has to switch the MBS mode from PTM to PTP or vice versa. The command may include information (e.g., additional information), such as RLC state variables for the RLC entity associated with the MBS mode that the command indicates switch to. The WTRU may update the RLC state variables of the RLC entity, e.g., according to the indicated values. The WTRU may start operating in the MBS mode that the command indicates to switch to. In the case of an MBS mode switch from PTP to PTM, the WTRU may monitor (e.g., start monitoring) for a G-RNTI (e.g., the G-RNTI associated with the MRBs that are associated with the PTM mode) in transmission(s) on a PDCCH (e.g., if the WTRU is not doing so). In the case of an MBS mode switch from PTM to PTP, the WTRU may stop monitoring for a C-RNTI in transmission(s) on the PDCCH. In the case of an MBS mode switch from PTM to PTP, the WTRU may monitor (e.g., start monitoring) for the C-RNTI in transmission(s) on the PDCCH (e.g., if the WTRU is not doing so). In the case of an MBS mode switch from PTM to PTP, the WTRU may stop monitoring for the G-RNTI in transmission(s) on the PDCCH.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 10 is a system diagram illustrating an example radio access network (RAN) and an example core network (CN) that may be used within the communications system illustrated in FIG. 1A according to an embodiment.

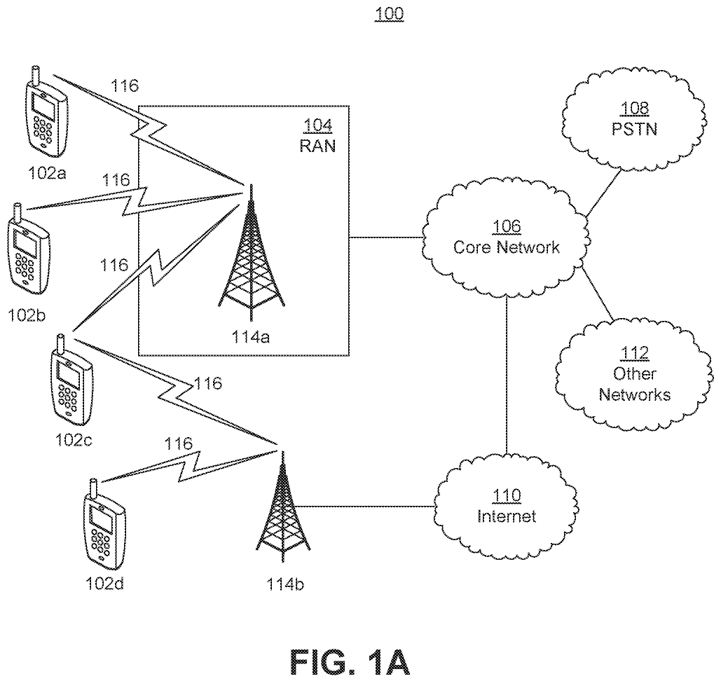

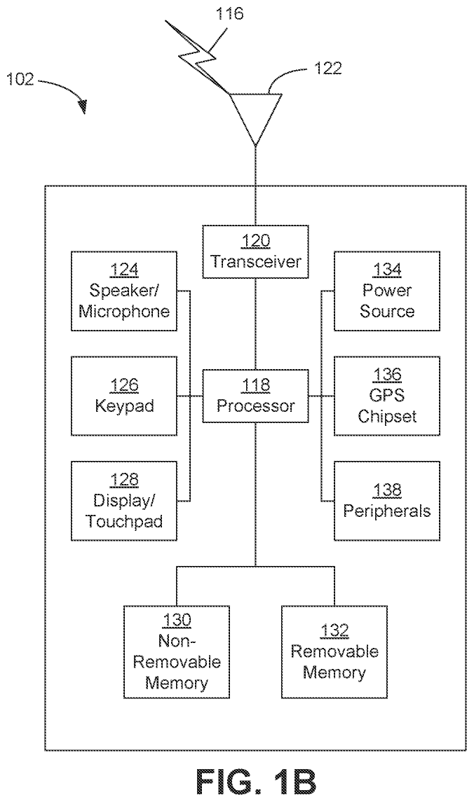

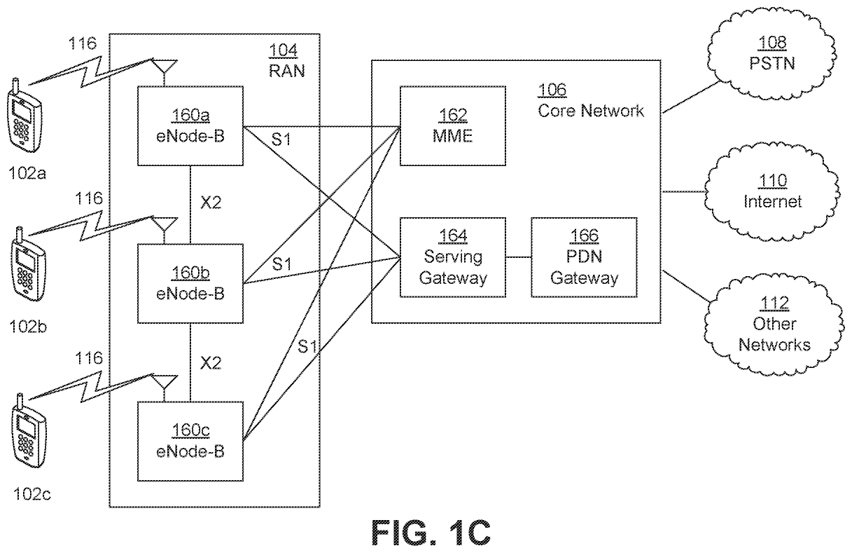

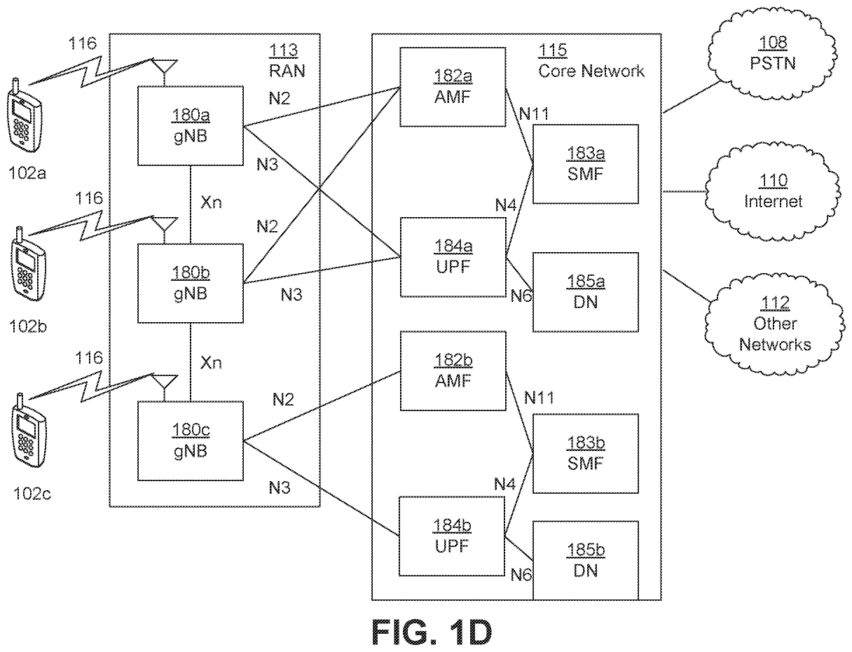

FIG. 1D is a system diagram illustrating a further example RAN and a further example CN that may be used within the communications system illustrated in FIG. 1A according to an embodiment.

FIG. 2 illustrates an example of a protocol architecture.

FIG. 3 illustrates an example associated with switching MBS modes.

### DETAILED DESCRIPTION

Reference to a timer herein may refer to a time, a time period, tracking the time, tracking the period of time, etc. Reference to a timer expiration herein may refer to determining that the time has occurred or that the period of time has expired. Reference to that a timer is running may refer to determining that it is during the time period.

Systems, methods, and instrumentalities are described herein for lossless switching between point-to-point (PTP) and point-to-multipoint (PTM) transmission and reception in multicast and broadcast services (MBS). A wireless transmit/receive unit (WTRU) may be configured to trigger an MBS mode switch request towards the network (e.g., PTP to PTM or vice versa), for example, depending on the performance of the current MBS mode (e.g., considering radio link signal levels, hybrid automatic repeat request (HARQ) failures/success rates, retransmission counts, and/or the like). A WTRU may be configured to (e.g., implicitly) switch the MBS mode from PTP to PTM, for example, based on (e.g., upon) reception of a packet data unit (PDU) over a radio link control (RLC) entity associated with the PTM. A WTRU may be configured to (e.g., implicitly) switch the MBS mode from PTM to PTP, for example, based on (e.g., upon) reception of a PDU over an RLC entity associated with the PTP. A WTRU may be configured to modify the behavior of an RLC receiver (e.g., window size, starting and ending SNs of the receiver window, PDU discard behavior, and/or the like), for example, based on (e.g., implicitly) switching the MBS mode. A WTRU may receive a message from the network (e.g., radio resource control (RRC) reconfiguration, medium access control (MAC) control element (CE), and/or downlink control information (DCI)) and may switch the MBS mode (e.g., PTP to PTM or vice versa) and/or set the RLC state parameters to those indicated in the message. A WTRU may change the physical downlink control channel (PDCCH) monitoring behavior (e.g., monitor for the cell radio network temporary identifier (C-RNTI) only, monitor for the group RNTI (G-RNTI) only, or monitor for both the C-RNTI and G-RNTI), for example, before/during/after performing an MBS mode switch.

Systems, methods, and instrumentalities are described herein associated with lossless switching between point-to-point (PTP) and point-to-multipoint (PTM) transmission and reception, e.g., in multicast and broadcast services (MBS). A wireless transmit-receive unit (WTRU) may receive an indication to switch from using point-to-point (PTP) operation (e.g., from a PTP transmission mode) to using point-to-multipoint (PTM) operation (e.g., to a PTM transmission mode) or determine to switch from using PTP operation (e.g., from the PTP transmission mode) to using PTM operation (e.g., to the PTM transmission mode) based on a reliability condition associated with PTM operation (e.g., the PTM mode). Based on the indication or the determination, the WTRU may switch from using PTP operation (e.g., from the PTP transmission mode) to using PTM operation (e.g., to the PTM transmission mode). The WTRU may receive a first data packet. The WTRU may extend a data packet reception window by extending a boundary of the data packet reception window. The boundary may be extended based on a sequence number (SN) of the first data packet and an offset. In some examples, the WTRU may receive a second data packet and add the second data packet to a reception buffer for processing and the addition may be based on a second SN of the second data packet being within an extended part of the extended data packet reception window. In some examples, the boundary of the data packet reception window may be a starting edge of the data packet reception window and extending the boundary of the data packet reception window may include setting a first value of the starting edge to a second value that is lower than the SN of the first data packet by the offset. In some examples, the extended part of the extended data packet reception window may be a part of the extended data packet reception window that starts at the second value and ends at the SN of the first data packet.

A WTRU may receive a first data packet. The WTRU may determine to switch from using PTM operation (e.g., from a PTM transmission mode) to using PTP operation (e.g., to a PTP transmission mode) based on a reliability condition associated with using PTM operation (e.g., the PTM transmission mode). Based on the determination, the WTRU may send a request to switch from using PTM operation (e.g., from the PTM transmission mode) to using PTP operation (e.g., to the PTP transmission mode). The WTRU may receive an indication to switch from using PTM operation (e.g., from the PTM transmission mode) to using PTP operation (e.g., to the PTP transmission mode). Based on the indication, the WTRU may switch from using PTM operation (e.g., from the PTM transmission mode) to using PTP operation (e.g., to the PTP transmission mode) and may send a data packet status report. The data packet status report may indicate the first data packet was received.

A WTRU may, as shown by example in FIG. 3, trigger an MBS mode switch(es) (e.g., based on an indication, such as an indication received from the network, or, based on a determination by the WTRU). A WTRU (e.g., see 304 in FIG. 3) may be configured for MBS and may be configured with one or more Multicast Radio Bearers (MRBs) (e.g., see 308 in FIG. 3). The WTRU may receive configuration information from the network (e.g., see 306 in FIG. 3), which may include parameters/thresholds (e.g., to be used) for triggering MBS mode switching. The parameters/thresholds may include signal levels/thresholds concerning a serving cell (e.g., reference signal received power (RSRP) level(s)/threshold(s), reference signal received quality (RSRQ) level(s)/threshold(s), received signal to noise indicator (RSNI) level(s)/threshold(s), and/or the like), HARQ failure/success rate(s) level(s)/threshold(s), retransmission count(s) of the MRB(s) level(s)/threshold(s), etc. The WTRU may monitor performance of the MBS operation (e.g., according to the configuration information or a WTRU implementation). The WTRU may determine to switch the MBS mode. For example, the WTRU (e.g., if operating in a PTM mode) may determine to switch to a PTP mode, e.g., if the signal level of the serving cell falls below a threshold and/or if a HARQ failure rate/retransmission count is above a threshold (e.g., see 310 in FIG. 3). The WTRU may send an MBS mode switch request when determining to switch MBS mode, for example, from PTM to PTP, or vice versa (e.g., see 312 in FIG. 3). The request may include information, such as a packet data convergence protocol (PDCP)/RLC receive status report, MRBs affected (e.g., MRB(s) associated with the mode the WTRU requests to switch to), etc. A PDCP/RLC receive status report may be sent, e.g., separately from the request (e.g., see 314 in FIG. 3). The WTRU may receive an indication from the network (e.g., see 306 in FIG. 3) to switch from PTM to PTP (e.g., at 313 in response to 312, as shown in FIG. 3). A WTRU may change PDCCH transmission monitoring behavior (e.g., monitor for a C-RNTI only, monitor for a G-RNTI only, or monitor for both the C-RNTI and G-RNTI), for example, before/during/after sending the MBS mode switch request.

In examples, a WTRU (e.g., see 304 in FIG. 3) may switch (e.g., implicitly switch) an MBS mode (e.g., perform an implicit MBS mode switch). A WTRU may be configured for MBS and may be configured with one or more MRBs. The WTRU may receive configuration information from the network (e.g., see 306 in FIG. 3) specifying the WTRU behavior, e.g., for the case that the WTRU is operating in a PTP mode and an RLC PDU is received, e.g., where the RLC PDU is associated with a PTM mode, e.g., with an associated RLC entity being associated with a PTM mode. The WTRU (e.g., if operating in the PTP mode) may receive an RLC PDU (e.g., a trigger PTM RLC PDU, for example, an RLC PDU that triggers a switch to PTM), e.g., where the RLC PDU is associated with a PTM mode, e.g., with the associated RLC entity being associated with the PTM. The WTRU may (e.g., based on the configuration information) determine (e.g., consider) the reception of the RLC PDU as an implicit MBS mode switch request from the network (e.g., see 319 in FIG. 3). The WTRU may start a time period (e.g., a timer). The value of the time period (e.g., the timer) may be specified in the received configuration information. The WTRU may (e.g., during the time period (e.g., while the timer is running)) operate the PTM RLC entity in a mode (e.g., a special (e.g., RLC) mode). The special RLC mode may be or may implement one or more of the following (e.g., as may be indicated in the received configuration information or may be otherwise configured): refrain from discarding PDUs with a sequence number (SN) lower than an SN of the trigger PTM RLC PDU and forward the PDUs to a PDCP layer; extend a RLC window size by decrementing a receive RLC window left edge by an offset (e.g., a determined, selected, or configured offset, such as half of the receive RLC window size) (e.g., see 320 in FIG. 3); extend the RLC window size by incrementing the receive RLC window right edge by an offset (e.g., a determined, selected, or configured offset, such as half of the receive RLC window size); operate the RLC in a windowless or transparent RLC like mode, for example, by forwarding received PDUs (e.g., all received PDUs) to a PDCP layer; or operate the PTM RLC entity in a UM mode (e.g., a normal UM mode), for example, if the time period elapses (e.g., the timer expires).

In examples, a WTRU (e.g., see 304 in FIG. 3) may switch (e.g., explicitly switch) an MBS mode (e.g., perform an explicit MBS mode switch). A WTRU may be configured for MBS and may be configured with one or more MRBs. The WTRU may receive a command from the network (e.g., an RRC reconfiguration, a MAC CE, a DCI, and/or the like) (e.g., see 313 and 319 in FIG. 3). The command may indicate (e.g., specify) that the WTRU has to switch the MBS mode from PTM to PTP or vice versa. The command may include information (e.g., additional information), such as RLC state variables for the RLC entity associated with the MBS mode that the command indicates switch to. The WTRU may update the RLC state variables of the RLC entity, e.g., according to the indicated values. The WTRU may start operating in the MBS mode that the command indicates to switch to. In the case of an MBS mode switch from PTP to PTM, the WTRU may monitor (e.g., start monitoring) for a G-RNTI (e.g., the G-RNTI associated with the MRBs that are associated with the PTM mode) in transmission(s) on a PDCCH (e.g., if the WTRU is not doing so). In the case of an MBS mode switch from PTM to PTP, the WTRU may stop monitoring for a C-RNTI in transmission(s) on the PDCCH. In the case of an MBS mode switch from PTM to PTP, the WTRU may monitor (e.g., start monitoring) for the C-RNTI in transmission(s) on the PDCCH (e.g., if the WTRU is not doing so). In the case of an MBS mode switch from PTM to PTP, the WTRU may stop monitoring for the G-RNTI in transmission(s) on the PDCCH.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

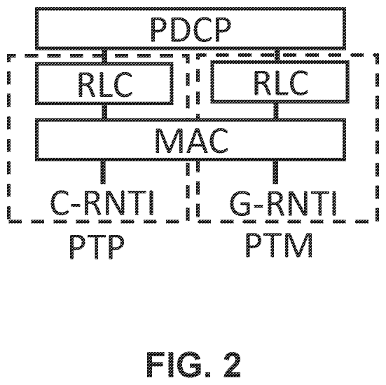

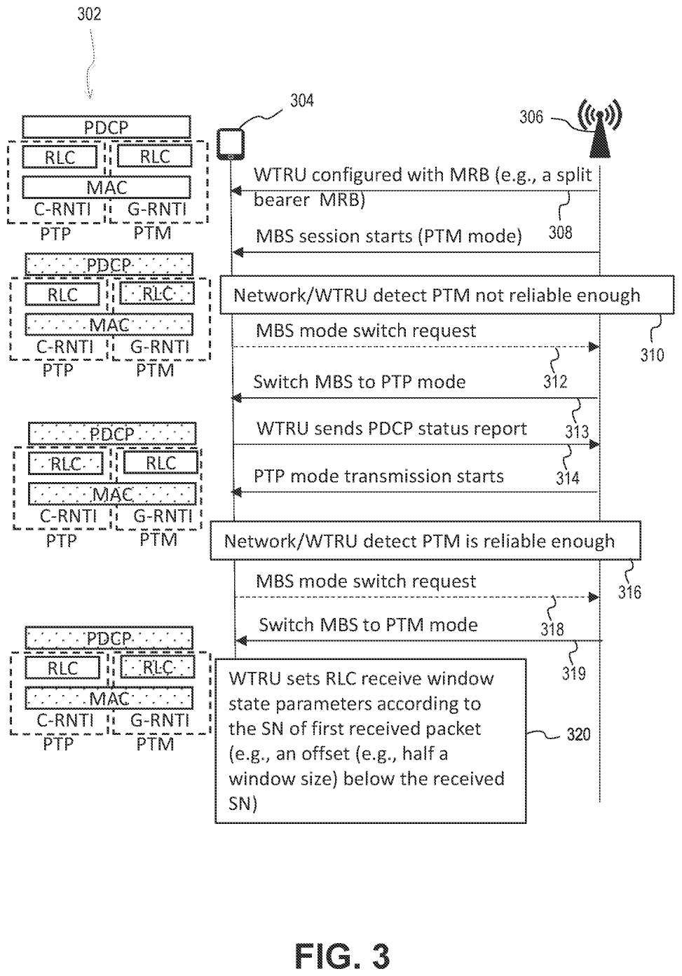

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The disclosed systems, methods, and instrumentalities, e.g., including non-limiting examples, do not limit the applicability of the systems, methods, and instrumentalities described herein (e.g., to other wireless technologies). The term network may refer to one or more gNBs, which may be associated with one or more transmission/reception points (TRPs) and/or to any other node in a radio access network (RAN).

Multimedia broadcast multicast system (MBMS) services may be delivered over a wireless network, for example, according to (e.g., via) a number of methods, which may include one or more of the following: unicast cellular transmissions (UC), multicast-broadcast single frequency network (MBSFN), or single cell point to multipoint (SC-PTM).

SC-PTM may support broadcast/multicast services, e.g., over a single cell. A broadcast/multicast area may be adjusted (e.g., dynamically) cell by cell, e.g., according to user distribution. SC-PTM may transfer broadcast/multicast services, for example, using a downlink channel (e.g., an LTE downlink shared channel, such as PDSCH), which may be scheduled using an RNTI (e.g., a common RNTI, such as a group-RNTI) for a group of users. SC-PTM scheduling may be agile. Radio resources may be assigned (e.g., dynamically) in time and/or frequency domain by PDCCH, for example, based on real-time traffic load transmission time interval (TTI) by TTI (e.g., in integer multiples of one or more symbols). SC-PTM may be applied, for example, if broadcast/ multicast service is (e.g., is expected to) be delivered to a limited number of cells (e.g., due to user interests) and the cells may (e.g., dynamically) change (e.g., due to user movement). SC-PTM may allow efficient radio utilization and/or flexible deployment of a number of applications, e.g., critical communications, traffic information for cars and on-demand TV services, etc.

MBSFN may arrange transmissions from different cells (e.g., to be identical and/or time aligned) to appear as a transmission (e.g., a single transmission) from a WTRU perspective. Time synchronization among base stations (e.g., eNBs) may be enabled, for example, by (e.g., a notion of) MBSFN synchronization areas. An MBSFN area may include a group of cells within an MBSFN synchronization area of a network coordinated to achieve an MBSFN transmission. MBMS architecture may include (e.g., define) various logical entities to perform network functions applicable for MBMS transmission(s). A multi-cell/multi-cast coordination entity (MCE) may perform admission control, determine whether to use SC-PTM or MBSFN, suspend and resume for MBMS services, and/or the like. An MBMS gateway (MBMS-GW) may perform session control signaling, forward MBMS user data to eNBs (e.g., via IP multicasting), and/or the like.

MBMS (e.g., in LTE) may support unicast, SC-PTM, and/or MBSFN transmissions. Frequency domain resource allocation may not be supported, for example, if an MBMS transmission consumes too much (e.g., all) bandwidth (BW), which may be inefficient in deployments with large bandwidths.

MBMS may be referred to as MBS (multicast and broadcast services), e.g., in new radio (NR). The terms MBMS and MBS may be used interchangeably.

A WTRU may be configured with a transmission mode (e.g., if MBS is configured). A transmission mode may include one or more transmission methods, such as unicast, multicast (e.g., SC-PTM), broadcast (e.g., SFN), mixed-mode (e.g., the WTRU may receive unicast, and multicast and/or broadcast), and the like. Transmission mode is non-limiting in scope and applicability (e.g., transmission mode may be applicable to similar wireless delivery methods). One or more non-unicast modes may include a receive-only mode (ROM). A transmission mode may include a sidelink interface (e.g., for direct WTRU-to-WTRU communications). A transmission mode may be used for delivery of services with different quality of service (QoS), e.g., enhanced Mobile Broadband (eMBB), ultra-high reliability and low latency communications (URLLC), and/or MBS services. A transmission mode may be used for delivery of services to one receiver (e.g., via unicast) or multiple receivers (e.g., via multicast, groupcast, or broadcast). Examples of services to multiple users may include vehicle to everything (V2X) services (e.g., groupcast) and MBS services (e.g., multicast, broadcast). MBS mode and/or MBS transmission mode may (e.g., be used to) refer to a WTRU's transmissions mode.

A WTRU may be configured for delivery (e.g., transmission) of MBMS data services. A WTRU may be configured to operate with a transmission mode to exchange MBS-related data and/or control information (e.g., and/or other data and/or control information). A WTRU may be (e.g., further) configured for the delivery of MBS services. For example, a WTRU may be configured for mapping of data bearers and/or signaling bearers for configured transmission method(s) to exchange MBS-related data (e.g., L2 bearer configuration for MBS). In some examples, a WTRU may be configured for mixed-mode transmissions (e.g., unicast and multicast) with the delivery of MBS data performed using (e.g., only using) multicast and/or broadcast transmissions, and/or with other services being transmitted over unicast (e.g., eMBB, URLLC). In some examples, a WTRU may be configured for mixed-mode transmissions (e.g., unicast and multicast), with delivery of MBS data performed using unicast (e.g., referred to as Point-to-Point (PTP) transmission/mode) and/or multicast transmissions (e.g., referred to as Point-to-MultiPoint (PTP) transmission/mode), for example, irrespective of whether the WTRU is active with other services, such as unicast transmissions (e.g., eMBB, URLLC).

MBMS (e.g., in NR) may be utilized in a variety of deployments and may support one or more of the following: V2X; sidelink; public safety; IoT (e.g., narrowband (NB) IoT and enhanced machine type communications (eMTC)) devices (e.g., for software updates); smart grids/utilities; television (TV) video and radio services in 5G (e.g., linear TV, Live, smart TV, managed and over-the-top (OTT) content distribution, radio services), which may include video distribution, large peaks in concurrent consumption of OTT services via unicast media streams, and/or immersive six degrees of freedom (6 DoF) volumetric streaming); push services (e.g., advertisements and weather broadcast); ethernet broadcast/multicast for factory automation; Xtended reality, group gaming; etc.

Various MBS-related enabling capabilities (e.g., enablers) may be provided (e.g., for NR). Service switching may occur between PTP, PTM, and mixed mode operations. A change in service may be triggered, for example, due to one or more of the following: WTRU mobility, user activity, WTRU density, or a link condition. WTRU mobility may include different scenarios for a mode switch, such as one or more of the following: PTP to PTP; PTP to PTM; PTP to PTM+PTP; PTM to PTP; PTM to PTM; PTM to PTM+PTP; PTM+PTP to PTP; PTM+PTP to PTM; and/or PTM+PTP to PTM+PTP. WTRU mobility may include different handover scenarios, such as one or more of the following: intra-eNB/intra-MBS area inter-cell mobility; inter-eNB/intra-MBS area Inter-cell mobility; inter-MBS area mobility; inter-RAT mobility with a change of transmission mode; or inter-RAT mobility without a change of transmission mode. A triggered change in service (e.g., due to WTRU mobility) may occur with or without service continuity, which may be lossy or lossless. WTRU mobility issues may include enabling service continuity for IDLE/INACTIVE WTRUs.

User activity (e.g., as a trigger for a change in service) may include, for example, one or more of the following: user control over a media stream (e.g., a user may interact with a playback function and have some control over the media stream); or end user interaction with live or shared content via an uplink channel for user engagement and/or monetization (e.g., video distribution, advertising, and/or public safety).

WTRU density (e.g., as a trigger for a change in service) may include one or more of the following: a change in the number of users acquiring and receiving an MBS service (e.g., a threshold may be met, in which case system efficiency may be increased by changing an MBS transmission mode); or for V2X proximity/WTRU range within an area. A link condition (e.g., as a trigger for a change in service) may include the following: different characteristics for resources between multicast and unicast transmissions for a WTRU (e.g., the quality may become lower for a first resource compared to a second resource).

Dynamic control of transmission resources and/or delivery areas may be implemented (e.g., in NR). Dynamic control of transmission resources and/or delivery areas may be based on (e.g., motivated by) one or more of the following: regional TV/radio services occur at certain times of the day; fluctuation/variation in on-demand MBS services (e.g., in services with support for uplink data or in terms of support for higher reliability); or a target area for group communication and live video may be based on a specific area or place or triggered by an event, where the area may change (e.g., due to the mobility of interested users). A change in MBS area may be slower (e.g., in terms of time scale) than adjusting resources between unicast (UC)/multicast broadcast (MB)/broadcast (BC).

Reliability of transmissions may be implemented/improved (e.g., in NR). MBS service may support application level retransmissions. Application level methods may have a reliability and efficiency tradeoff, which may be costly in terms of spectrum efficiency. Application level methods may not meet lower latency requirements. Different MBS services may have different latency, efficiency, and/or reliability requirements. In some examples, MBS service may have severe degradation with doppler, which may make it difficult to use the MBS service in high speed environments. In examples, power grid distribution (e.g., in NR) may be implemented to have a delay of 5 ms and packet error rate of 10-6. V2X (e.g., in NR) may be implemented to have a latency of at most 20 ms for information sharing between a WTRU and a road side unit (RSU). Mission critical push to talk (MCPTT) (e.g., in NR) may be implemented to have a latency of at most 300 ms (e.g., for mouth-to-ear latency).

Devices that may be deployed as MBS receivers (e.g., in NR) may range from read-only mode (ROM) WTRUs (e.g., devices that may not be capable and/or may not be expected to perform uplink transmissions for acquiring and receiving MBS transmissions) to WTRUs implementing more complex functionality (e.g., including functions and procedures utilizing uplink transmissions). Some (e.g., more complex) WTRUs may support carrier aggregation, dual connectivity, multiple radio interfaces active concurrently, and/or (e.g., concurrent) operation across different frequency ranges (e.g., FR1 and FR2).

A radio link control (RLC) protocol may include a layer 2 protocol that lies between the packet data convergence protocol (PDCP) and the medium access control (MAC) protocols and may facilitate transfer of data between the two layers. RLC protocol functionality (e.g., tasks) may include one or more of the following: transfer of upper layer protocol data units (PDUs) in one of multiple (e.g., three) modes (e.g., an acknowledged mode (AM), an unacknowledged mode (UM), and a transparent mode (TM)); error correction (e.g., through an automatic repeat request (ARQ), which may be for (e.g., only for) AM data transfer); segmentation and/or reassembly of RLC service data units (SDUs) (e.g., for UM and/or AM); re-segmentation of RLC data PDUs (e.g., for AM); duplicate detection (e.g., for AM); RLC SDU discard (e.g., for UM and AM); RLC re-establishment; and/or protocol error detection (e.g., for AM).

Multiplexing data (e.g., in LTE) may be implemented multiple (e.g., two) times, for example, by concatenating RLC SDUs from a logical channel into an RLC PDU in an RLC layer and by multiplexing RLC PDUs from different logical channels into a MAC PDU in a MAC layer. A MAC PDU may carry the information about a same data field in the RLC and MAC (sub-)headers. The RLC concatenation may include input from MAC layer scheduling (e.g., interaction with MAC may be used to construct the RLC PDUs that have the proper size for each UL grant). An RLC concatenation may be performed (e.g., within one scheduling cycle), for example, in response to receiving a scheduling decision (e.g., an uplink grant size) and performing an LCP procedure in the MAC layer. The RLC concatenation process may imply that the RLC and MAC layers may not perform pre-processing without (e.g., before receiving) the grant information. An inability to preprocess without grant information (e.g., before grant information is received) may be limiting for very high data rate and low latency requirements (e.g., in NR). In some examples, a concatenation procedure may not occur in an NR RLC layer. The RLC may send PDCP packets to the MAC in response to (e.g., immediately in response to) header addition. The MAC layer may concatenate/multiplex the data from multiple RLC PDUs and may send it over an air interface, for example, in response to the MAC layer receiving the scheduling grant and transport block size (TBS) indication.

An RLC (e.g., a LTE RLC) may have a re-ordering functionality. Reordering may be performed (e.g., in NR) by a PDCP layer, which may have a re-ordering functionality. Performance of reordering by a PDCP layer may improve latency, for example, e.g., delivering out of order RLC packets to the PDCP layer may allow earlier deciphering of the out of order packets.

RLC UM operation may use state variable(s), constant(s), and timer(s)). A transmitting UM RLC entity (e.g., each transmitting UM RLC entity) may maintain the following state variable: TX_Next (e.g., a UM send state variable). The TX_Next state variable may hold a value of an SN to be assigned for a next (e.g., newly) generated unacknowledged mode data (UMD) PDU with segment(s). TX_Next may initially be set to 0. TX_Next may be updated, for example, in response to the UM RLC entity submitting a UMD PDU, which may include a last segment of an RLC SDU, to lower layers.

A receiving UM RLC entity (e.g., each receiving UM RLC entity) may maintain one or more of the following state variables: RX_Next_Reassembly (e.g., a UM receive state variable); RX_Timer_Trigger (e.g., a UM t-Reassembly state variable); or RX_Next_Highest (e.g., a UM receive state variable).

RX_Next_Reassembly (e.g., a UM receive state variable) may hold a value of an earliest SN that may (e.g., still) be considered for reassembly. In some examples, RX_Next_Reassembly may initially be set to 0. In some examples (e.g., for groupcast and broadcast of NR sidelink communication), RX_Next_Reassembly may initially be set to an SN of a first received UMD PDU that includes an SN. PDUs with a lower SN may be considered to be received and/or lost.

RX_Timer_Trigger (e.g., a UM t-Reassembly state variable) may hold a value of a SN following a SN that triggered (e.g., started) a t-Reassembly described herein.

RX_Next_Highest (e.g., a UM receive state variable) may hold a value a SN following the SN of a UMD PDU with a highest SN among received UMD PDUs. In some examples, RX_Next_Highest may initially be set to 0. In some examples (e.g., for groupcast and broadcast of NR sidelink communication), RX_Next_Highest may initially be set to an SN of a first received UMD PDU that includes an SN.

UM_Window_Size may be a constant. UM_Window_Size may be used by a receiving UM RLC entity to define SNs of the UMD SDUs that may be received, e.g., without causing an advancement of a receiving window. In some examples, UM_Window_Size may equal 32, e.g., if a 6-bit SN is configured. In some examples, UM_Window_Size may equal 2048, e.g., if a 12-bit SN is configured. An RLC reception window may be considered to be SNs between RLC_Next_Reassembly and RLC_Next_Reassabmly+UM_Window_Size. RX_Next_Reassembly may be considered to be a left edge, starting edge or lower edge of the RLC receive window. RX_Next_Reassembly+UM_Window_Size may be considered to be a right edge, ending edge or higher edge of the RLC receive window.

t-Reassembly may be a timer. t-Reassembly may be used by a receiving side of an AM RLC entity and an receiving UM RLC entity, for example, to detect loss of RLC PDUs at a lower layer. A second t-Reassembly may not be started, for example, if a first t-Reassembly is running. In some examples, only one t-Reassembly per RLC entity may be running at a time (e.g., a given time).

Receive operations may be performed. A receiving UM RLC entity may maintain a reassembly window, for example, according to a state variable RX_Next_Highest. An SN may fall within the reassembly window, for example, if (RX_Next_Highest-UM_Window_Size)<=the SN<RX_Next_Highest. An SN may fall outside of the reassembly window, for example, if otherwise.

A UM RLC receiving entity may (e.g., if an UMD PDU is received from a lower layer) deliver the received UMD PDU to an upper layer after removing an RLC header, discard the received UMD PDU, or place the received UMD PDU in a reception buffer. The UM RLC receiving entity may update state variables, reassemble and deliver RLC SDUs to a upper layer, and start/stop t-Reassembly (e.g., as needed), for example, if an UMD PDU is received from a lower layer and the received UMD PDU was placed in the reception buffer. The UM RLC receiving entity may update state variables, discard RLC SDU segments, and start t-Reassembly (e.g., as needed), for example, if t-Reassembly expires.

A UMD PDU may be received by a UM RLC entity from a lower layer. The receiving UM RLC entity may (e.g., if a UMD PDU is received from a lower layer) remove an RLC header and deliver the RLC SDU to an upper layer, for example, if the UMD PDU header does not include an SN. The receiving UM RLC entity may discard the received UMD PDU, for example, if (RX_Next_Highest — UM_Window_Size)<=an SN<RX_Next_Reassembly. The receiving UM RLC entity may place the received UMD PDU in a reception buffer, for example, if otherwise.

A UMD PDU may be placed in the reception buffer. The receiving UM RLC entity may (e.g., based on a UMD PDU with SN=x being placed in the reception buffer) reassemble an RLC SDU from byte segments (e.g., all byte segments) with SN=x, remove RLC headers, and deliver the reassembled RLC SDU to an upper layer, for example, if byte segments (e.g., all byte segments) with SN=x are received. The receiving UM RLC entity may (e.g., based on a UMD PDU with SN=x being placed in the reception buffer) update RX_Next_Reassembly to the SN of a first SN greater than (e.g., >) a (e.g., current) RX_Next_Reassembly that has not been reassembled and delivered to an upper layer, for example, if x=RX_Next_Reassembly.

The receiving UM RLC entity may (e.g., based on a UMD PDU with SN=x being placed in the reception buffer) update RX_Next_Highest to x+1 and/or discard UMD PDUs (e.g., any UMD PDUs) with an SN that falls outside of the reassembly window, for example, if x falls outside of the reassembly window. The receiving UM RLC entity may (e.g., based on a UMD PDU with SN=x being placed in the reception buffer) set RX_Next_Reassembly to the SN of a first SN greater than or equal to (e.g., >=) (RX_Next_Highest-UM_Window_Size) that has not been reassembled and delivered to an upper layer, for example, if RX_Next_Reassembly falls outside of the reassembly window.

The receiving UM RLC entity may (e.g., based on a UMD PDU with SN=x being placed in the reception buffer) stop and reset t-Reassembly, for example, if t-Reassembly is running and one or more of the following is true: RX_Timer_Trigger<=RX_Next_Reassembly; RX_Timer_Trigger falls outside of the reassembly window and RX_Timer_Trigger is not equal to RX_Next_Highest; or RX_Next_Highest=RX_Next_Reassembly+1 and there is no missing byte segment of the RLC SDU associated with SN =RX_Next_Reassembly before the last byte of received segments (e.g., all received segments) of the RLC SDU.

The receiving UM RLC entity may (e.g., based on a UMD PDU with SN=x being placed in the reception buffer) start t-Reassembly and/or set RX_Timer_Trigger to RX_Next_Highest, for example, if t-Reassembly is not running (e.g., including the case that t-Reassembly is stopped as described herein) and one or more of the following is true: RX_Next_Highest>RX_Next_Reassembly+1; or RX_Next_Highest=RX_Next_Reassembly+1 and there is at least one missing byte segment of the RLC SDU associated with SN=RX_Next_Reassembly before the last byte of received segments (e.g., all received segments) of this RLC SDU.

The timer t-Reassembly may expire. The receiving UM RLC entity may (e.g., based on t-Reassembly expiring) may update RX_Next_Reassembly to the SN of the first SN greater than or equal to (e.g., >=) RX_Timer_Trigger that has not been reassembled; or discard segments (e.g., all segments) with an SN less than (e.g., <) the updated RX_Next_Reassembly. The receiving UM RLC entity may (e.g., based on t-Reassembly expiring) may start t-Reassembly; and/or set RX_Timer_Trigger to RX_Next_Highest, for example, if RX_Next_Highest>RX_Next_Reassembly+1; and/or if RX_Next_Highest=RX_Next_Reassembly+1 and there is at least one missing byte segment of the RLC SDU associated with SN=RX_Next_Reassembly before the last byte of received segments (e.g., all received segments) of the RLC SDU.

In an example of MBS, a WTRU may join a multicast in the case that a session has started, or the WTRU may start the session in a PTP mode and may (e.g., later) switch to a PTM mode, for example, due to an improvement in radio conditions, which may enable the WTRU to receive the multicast session via a broad beam used for a PTM mode; due to mobility to a cell that supports a PTM mode (e.g., only a PTM mode); etc.

State variable(s) that control(s) an RLC reception window (e.g., an RX_Next_Reassembly and/or an RX_Next_Highest) may be initialized (e.g., to 0), for example, if a UM RLC entity is established. State variable(s) that control(s) an RLC reception window may be set to an SN of a first received UMD PDU (e.g., if the first received UMD PDU includes an SN), for example, in the case of NR sidelink groupcast/broadcast communication (e.g., because a WTRU may join a groupcast/broadcast after the session has started).

In an example of a PTM mode, a WTRU may switch from a PTP mode to a PTM mode, or may join an MBS session in a PTM mode. The state variable(s) may be initialized to an SN of a first received PDU in response to switching to a PTM mode (e.g., a PTM RLC mode). This approach may be unsuitable, for example, for lossless switching to a PTM mode. For example, a first RLC PDU that may be received (e.g., if switching to a PTM mode or joining an MBS session in a PTM mode after the session has started) may be out of order, e.g., with a SN of x. A RLC receiver may discard the first RLC PDU received, for example, if a starting edge of a RLC receive window is initialized to the SN of the first received PDU and a missing RLC packet is received (e.g., later) out of order (e.g., an RLC packet with a SN x-n).

RLC UM operation may be improved, for example, for enabling lossless switching from a PTP mode to a PTM mode operation in MBS.

Methods for lossless switching of MBS operation mode are described by example(s) based on transmissions and/or delivery of MBS services. The methods described herein are not limited to the example(s) (e.g., systems and services) described herein. The methods described herein may be applicable to more than one type (e.g., any type) of transmission and/or service, including but not limited to V2X, extended reality, gaming, IoT/MTC, industrial use cases, etc. The methods described herein may be implemented alone or in combination (e.g., within any MBS system).

A WTRU (e.g., configured for reception of data for an MBS) (e.g., see 304 in FIG. 3) may be configured with a data radio bearer (DRB) (e.g., a multicast radio bearer (MRB)), which may be dedicated to MBS reception (e.g., see step 308 in FIG. 3). An MBS service and an MRB may be considered equivalent (e.g., when discussed from the L2 and/or L3 perspective). An MBS service may be configured with zero, one, or more MRBs.

Multiple (e.g., several) QoS flows may be multiplexed within an MRB (e.g., similar to a DRB (e.g., a normal DRB)).

FIG. 2 illustrates an example of a protocol architecture (see also 302 in FIG. 3). As shown in FIG. 2 (and at step 308 in FIG. 3), an MRB may employ a split bearer-like configuration (e.g., with a PDCP entity and multiple (e.g., two) RLC entities. A first RLC entity may be for PTM operation and a second RLC entity may be for PTP operation.

A cell radio network identifier (C-RNTI) may (e.g., uniquely) identify a WTRU's RRC connection within a cell. A group RNTI (G-RNTI) may identify a group of VVTRUs participating in a multicast. A WTRU (e.g., configured with an MRB according to the example architecture shown in FIG. 2) may monitor DL scheduling for the MRB on the C-RNTI and/or G-RNTI. In the methods described here, it may be assumed that an RLC entity associated with PTM is operating in an unacknowledged mode (UM) and an RLC entity associated with PTP is operating in an acknowledged mode (AM). The methods disclosed herein may apply to other operation modes (e.g., PTM operating in a transparent mode (TM) or AM, or PTP operating in a TM or UM).

The methods described herein may be applicable to switching from PTP to PTM. The methods described herein may be applicable to other type(s) of switching (e.g., from PTM to PTP). In the examples described herein, the terms left edge, starting edge, and lower edge may be used interchangeably to denote a starting SN of an RLC receive window. In the examples described herein, the terms right edge, ending edge, and higher edge may be used interchangeably to denote an ending SN of an RLC receive window. In some examples (e.g., legacy operation), it may be assumed that PDUs with an SN outside an RLC receive window may be dropped by the receiver.

MBS mode switching may be triggered (e.g., see 312 and 318 in FIG. 3). In some examples, a WTRU may send information regarding a need to switch from PTM to PTP (e.g., see 312 in FIG. 3). The information may be sent in an RRC message (e.g., an MBSModeSwitchRequest message) or an information element (IE) may be included in an RRC message (e.g., an IE in an WTRUAssistancelnformation message). A WTRU may include in a request (e.g., an MBSModeSwitchRequest message or an IE in an WTRUAssistancelnformation message) a receiver status (e.g., in a PDCP and/or RLC entity) for an associated MRB (e.g., a concerned MRB) (e.g., see 314 in FIG. 3). In some examples, a WTRU may send the request to switch a mode of operation for multiple MRBs. In some examples, a WTRU may include in the request a status report (e.g., a PDCP status report, an RLC status report) corresponding to an MRB (e.g., each MRB) (e.g., see step in FIG. 3).

In some examples (e.g., legacy operation), PDCP status PDUs may be sent for DRBs operating in AM, e.g., during PDCP re-establishment, PDCP data recovery, and/or dual active protocol stack (DAPS) handover (e.g., in the case of uplink data switching or in the case that DAPS is released). PDCP status PDUs may be sent (e.g., in the case of UM DRBs), for example, during (e.g., only during) DAPS uplink data switching. In some examples, a WTRU may send a PDCP status PDU for an MRB without fulfilling legacy conditions for PDCP status reporting (e.g., if the WTRU detects that the PTM operation is degrading/satisfies a threshold condition, e.g., as detected based on frequent (e.g., above a threshold) HARQ failures/retransmissions and/or the signal level of the serving cell falling below a certain threshold, etc.) (e.g., see 310 in FIG. 3) The network (e.g., see 306 in FIG. 3) may interpret the PDCP status report (e.g., sent without fulfilling the legacy triggering conditions), for example, as an implicit request by the WTRU to switch an MBS mode (e.g., see 313 in FIG. 3). In some examples, the WTRU may determine to switch from the PTM mode to the PTP mode without sending a request to the network (e.g., 306 in FIG. 3), e.g., based on (e.g., only based on) that the WTRU detects that PTM operation is degrading/satisfies one or more threshold conditions described herein (e.g., 312 in FIG. 3 may not be performed).

In some examples, a flag/field may be implemented/utilized in a PDCP status report to indicate (e.g., explicitly) a request for switching an MBS mode.

In some examples, a switching request may be sent via an RLC control PDU (e.g., an RLC status PDU). In some examples (e.g., legacy RLC), status reporting may be applicable (e.g., only) to an AM mode. In some examples, status reporting may be implemented/utilized for a UM mode. Status reporting (e.g., for a UM mode) may be triggered, for example, if the WTRU determines to switch from a PTM to a PTP mode.

In some examples, a MAC control element (e.g., a new MAC control element) or an information element (e.g., a new information element) within existing MAC control elements may be used by the WTRU to request a switching of MBS mode.

In some examples, a WTRU may send a switching request to request a switch from PTP to PTM (e.g. see 318 in FIG. 3). A WTRU may request a switch to a PTM mode, for example, if one or more of the following conditions are true (e.g., see 316 in FIG. 3): there is an absence of HARQ retransmissions for an amount of time (e.g., a threshold amount time), which may be configured by the network; or if a signal level of the serving cell is above a threshold (e.g., a configurable threshold). The amount of time for which there is an absence of HARQ retransmissions (e.g., based on a threshold, a criterion, and/or other trigger(s)) may occur, for example, if a number of successful decodings of initial transmissions of a transport block associated with MBS within a time window is above a threshold. In some examples, the criterion may be if a number of ACKs transmitted within a time window is above a threshold or if a number of NACKs transmitted within a time window is below a threshold. In some examples, the WTRU may determine to switch from the PTP mode to the PTM mode without sending a request to the network (e.g., 306 in FIG. 3), e.g., based on (e.g., only based on) that the WTRU detects that the PTM operation is reliable/satisfies one or more conditions described herein (e.g., 318 in FIG. 3 may not be performed).

Examples described herein and variations thereof may be implemented. In examples, reception of an indication while a WTRU's MBS is operating in PTM mode may be interpreted by a network as a request by the WTRU to switch to PTP. Reception of an indication while a WTRU's MBS is operating in PTP may be interpreted as a request to switch to PTM. In some examples, information about a switch may be indicated (e.g., explicitly). For example, a Boolean field/flag may be included to indicate switching from PTP to PTM if a value of the field/flag is 0 or from PTM to PTP if a value of the field/flag is 1, or vice versa.

Switching (e.g., an MBS mode switching) may be implicit (see e.g., 313 and 319 in FIG. 3). In some examples (e.g., see 319 in FIG. 3), a WTRU operating in PTP may determine (e.g., consider or assume) that a MBS mode is switched from PTP to PTM, for example, in response to reception of an RLC PDU, e.g., via an RLC entity, associated with a PTM mode. In some examples (e.g., see 313 in FIG. 3), a WTRU operating in PTM may determine (e.g., consider or assume) that a MBS mode is switched from PTM to PTP, for example, in response to reception of an RLC PDU, e.g., via an RLC entity, associated with a PTP mode. An MBS mode switch may affect (e.g., only affect) an MRB associated with a received PDU (e.g., an MRB the received PDU belongs to) and a mode of operation for other MRBs may not be affected (e.g., the other MRBs may remain in a PTP mode if operating in a PTP mode, or may remain in a PTM mode if operating in a PTM mode). An MBS mode switch may affect multiple MRBs (e.g., all MRBs). An MBS mode switch may affect MRBs (e.g., all MRBs) associated with a same G-RNTI as the MRB that the received PDU belongs to.

Some examples may be based on timers. In some examples, a WTRU may be configured with a time period (e.g., a timer, which may be a t_switching timer). The time period (e.g., the timer) may be started, for example, in response to receiving an RLC PDU (e.g., the first RLC PDU) via an RLC entity associated with a PTM mode. PDUs received with an SN lower than an SN of the first received RLC PDU may be forwarded (e.g., immediately) to a PDCP layer (e.g., instead of being discarded), for example, during the time period (e.g., if the timer is running). The PTM RLC may operate (e.g., start operating) in a UM mode (e.g., a normal UM mode) and may discard PDUs that are outside the receive window, for example, if the time period has elapsed (e.g., the timer expires).

An extended window mode may be provided (e.g., configured, implemented, performed). A WTRU may be configured to operate in/operate in an extended window mode. A WTRU (e.g., operating in extended window mode) may maintain a receive window that is larger than a receive window in normal operation (e.g., in a normal mode). Normal mode and extended window mode may refer to, and may be used interchangeably with, first and second modes or vice versa. An extended window may be determined, for example, by using one or more offset values (e.g., preconfigured value(s), such as half of the receive window size) (e.g., see 320 in FIG. 3). For example, a first offset may be applied to a left edge of the window and a second offset may be applied to a right edge of the window. The reception window size may be extended, e.g., by the first offset+the second offset. The WTRU may be configured to place the received the PDUs in a reception buffer, for example, if an SN of the received PDU is within the extended window. The WTRU may be configured to discard the PDU, e.g., if an SN of the received PDU is not within the extended window.

A WTRU may be configured to operate in (e.g., apply) an extended window mode (e.g., see 320 in FIG. 3), for example, based on one or more of the following conditions: if a PTP to PTM switch is triggered (e.g., see 318 in FIG. 3); during a time period (e.g., if a timer (e.g., a t_switching timer) is running); if an MBS bearer is associated with multiple (e.g., two) configured and/or activated RLC entities (e.g., PTM RLC and PTP RLC); and/or in response to an indication (e.g., an explicit indication) (e.g., see 319 in FIG. 3) from the network (e.g., 306 in FIG. 3), which may be via a DCI, MAC CE, and/or RRC. An indication (e.g., an explicit indication) may activate or deactivate the operation.

A window-less RLC mode may be provided (e.g., configured, implemented, performed). In some examples, a WTRU may be configured to perform data reception for an MBS service, e.g., using an RLC entity in an RLC mode. For example, the RLC mode may be a window-less mode. The window-less RLC entity may perform one or more of the following: reassembling RLC SDUs from the received UMD PDUs or delivering the RLC SDUs to an upper layer (e.g., in response to that the RLC SDUs are available). An RLC entity operating in window-less mode may deliver a RLC SDU to higher/upper layer(s), for example, even if the PDU is outside the RLC receive window. In some examples, a window-less mode may be implemented (e.g., modeled) as an RLC function that behaves like a transparent mode for delivery of PDUs to higher layer(s) and/or a UM mode for handling reassembly and PDU processing.

In some examples, a window-less mode may be implemented by disabling the PDU discard function.

In some examples, a window-less RLC mode may be implemented (e.g., modeled) by disabling the RLC window associated with a UM RLC entity. The disabling may be triggered, for example, by one or more of the following: a PTP to PTM switch, a network command (e.g., an explicit network command), in response to reception of a PDU delivered based on scheduling via GRNTI, or the like.

A WTRU may be configured to apply a window-less RLC mode, for example, during a time period (e.g., if a timer, which may be a t_switching timer, is running). A WTRU may be configured to apply a window-less RLC mode, for example, if an MBS bearer is configured. A WTRU may apply window-less mode, for example, if an MBS bearer is associated with multiple (e.g., two) configured and/or activated RLC entities (e.g., PTM RLC and PTP RLC).

Window-less operation may result in duplicate PDUs being delivered to a PDCP layer. Duplicate PDUs may be discarded at the PDCP layer, e.g., via a duplication detection function. A WTRU may apply a window-less mode, for example, in response to an indication (e.g., an explicit indication) from the network, which may be via a DCI, MAC CE or RRC. An indication (e.g., an explicit indication) may activate or deactivate the operation.

Cell level switching may be provided (e.g., configured, implemented, performed). Cell level switching may include switching WTRUs (e.g., all WTRUs) that are involved in an MBS session from PTM to PTP, which may occur at the same time. A flag/IE/indicator (e.g., indicating cell level switching) may be provided in an RLC header. A flag/IE/indicator (e.g., indicating cell level switching) may be included on an RLC packet (e.g., a first RLC packet) transmitted from the network e.g., after the cell level switch to PTM operation. A WTRU may receive a packet including the RLC header. The WTRUs may set an SN of the received packet as the start of the receive window for the PTM RLC, e.g., in response to receiving the packet including the RLC header. PDUs (e.g., if any) that are received before the PDU that includes the indicator may be forwarded to a PDCP layer.

In some examples, an RLC PDU that includes the indicator (e.g., indicating cell level switching) may be lost (e.g., HARQ retransmission(s) may be unable to retrieve the MAC PDUs that include the RLC PDU). A time period (e.g., a timer) may be implemented, for example, to avoid the case that a WTRU waits for the PDU with the indicator that may not arrive. For example, a WTRU may start a timer (e.g., a t_switching timer) in response to reception of a first RLC PDU, e.g., after switching to a PTM mode. The WTRU may save an SN of the first received RLC PDU (e.g., first_SN). During the time period (e.g., if the timer is running), if a PDU with the indicator is received, the WTRU may initiate UM RLC state variables to the SN of the PDU, may stop the timer, and/or pass may the PDU to a PDCP layer and start operating in a normal UM mode. During the time period (e.g., if the timer is running), if no PDUs with the indicator are received, the WTRU may pass a PDU without the indicator to the PDCP layer. The WTRU may initiate the UM RLC state variables to the first_SN and/or may operate (e.g., start operating) in a normal UM mode, for example, if outside the time period (e.g., the timer expires).

In some examples, the network may indicate (e.g., via an indication in system information) to one or more VVTRUs (e.g., all WTRUs) within a cell to switch the MBS operation from PTM to PTP (or vice versa).

Explicit Switching may be provided (e.g., configured, implemented, performed) (e.g., see 313 and 319 in FIG. 3). Explicit switching may be implemented, for example, via RRC reconfiguration. In some examples, a WTRU may switch to a PTM mode in response to receiving an RRC reconfiguration message. An RRC reconfiguration message may include information about UM state variable(s), such as RX_next_reassambly and/or RX_next_highest. The WTRU may initiate a PTM RLC entity, for example, based on the RRC reconfiguration message to switch to PTM mode. A RRC reconfiguration message may include information regarding multiple MRBs.

In some examples, an information element (IE) may be included in the RLC UM configuration. The IE may indicate (e.g., specify) an initial SN that may be used for the UM state variables, e.g., as shown by example in Table 1.

An RRC reconfiguration message may include cellGroupConfig, which may include a list of RLC bearers (e.g., rlc-Bearers) to be added in the rlc-BearerToAddModList. A rlc-BearerConfig (e.g., each rlc-BearerConfig) may include configuration of an RLC entity (e.g., in addition to other related configuration that links the RLC entity with the PDCP entity and the MAC logical channel).

A CellGroupConfig IE may be used to configure a master cell group (MCG) or a secondary cell group (SCG). A cell group may comprise, for example, a MAC entity (e.g., one MAC entity), a set of logical channels (e.g., with associated RLC entities), a primary cell (e.g., a primary cell (SpCell) of a master or secondary cell group), and/or one or more secondary cells (SCells). Table 1 shows an example of a cell group configuration IE.

TABLE 1
Example of a CellGroupConfig information element

| | |
|---|---|
| CellGroupConfig ::= | SEQWTRUNCE { |
| cellGroupId | CellGroupId, |
| rlc-BearerToAddModList | SEQWTRUNCE (SIZE(1..maxLC-ID)) OF RLC-BearerConfig |
| OPTIONAL, --Need N | |
| <<Skipped parts>> | |
| } | |

An RLC-BearerConfig IE may be used to configure an RLC entity, a corresponding logical channel in MAC, and/or the linking to a PDCP entity (e.g., a served radio bearer). Table 2 shows an example of an RLC bearer configuration IE.

TABLE 2
Example of an RLC-BearerConfig information element

| | |
|---|---|
| RLC-BearerConfig ::= | SEQWTRUNCE { |
| logicalChannelIdentity | LogicalChannelIdentity |
| servedRadioBearer | CHOICE { |
| srb-Identity | SRB-Identity, |
| drb-Identity | DRB-Identity |
| } | |
| OPTIONAL, --Cond LCH-SetupOnly | |
| reestablishRLC | ENUMERATED{true} |
| OPTIONAL, --Need N | |
| rlc-Config | RLC-Config |
| OPTIONAL, --Cond LCH-Setup | |
| mac-LogicalChannelConfig | LogicalChannelConfig |
| OPTIONAL, --Cond LCH-Setup | |
| ..., | |
| [[ | |
| rlc-Config-v1610 | RLC-Config-v1610 |
| OPTIONAL --Need R | |
| ]], | |
| [[ | |
| rlc-Config-v17xx | RLC-Config-v17xx |
| OPTIONAL --Need R | |
| ]] | |
| } | |
| --TAG-RLC-BEARERCONFIG-STOP | |
| --ASN1STOP | |

An RLC-Config IE may be used to specify the RLC configuration of SRBs and/or DRBs. Table 3 shows an example of an RLC configuration IE.

TABLE 3
Example of an RLC-Config information element

--ASN1START

--TAG-RLC-CONFIG-START

| | |
|---|---|
| RLC-Config ::= | CHOICE{ |
| am | SEQWTRUNCE{ |
| ul-AM-RLC | UL-AM-RLC, |
| dl-AM-RLC | DL-AM-RLC |
| }, | |
| um-Bi-Directional | SEQWTRUNCE{ |
| ul-UM-RLC | UL-UM-RLC, |
| dl-UM-RLC | DL-UM-RLC |
| }, | |
| um-Uni-Directional-UL | SEQWTRUNCE{ |
| ul-UM-RLC | UL-UM-RLC |
| }, | |
| um-Uni-Directional-DL | SEQWTRUNCE{ |
| dl-UM-RLC | DL-UM-RLC |
| }, | |
| ... | |
| } | |
| UL-AM-RLC ::= | SEQWTRUNCE{ |
| sn-FieldLength | SN-FieldLengthAM |

OPTIONAL, --Cond Reestab

| | |
|---|---|
| t-PollRetransmit | T-PollRetransmit, |
| pollPDU | PollPDU, |
| pollByte | PollByte, |
| maxRetxThreshold | ENUMERATED {t1, t2, t3, t4, t6, 18, t16, t32} |
| } | |
| DL-AM-RLC ::= | SEQWTRUNCE{ |
| sn-FieldLength | SN-FieldLengthAM |

OPTIONAL, --Cond Reestab

| | |
|---|---|
| t-Reassembly | T-Reassembly |
| t-StatusProhibit | T-StatusProhibit |
| } | |
| UL-UM-RLC := | SEQWTRUNCE{ |
| sn-FieldLength | SN-FieldLengthUM |

OPTIONAL --Cond Reestab

| | |
|---|---|
| } | |
| DL-UM-RLC := | SEQWTRUNCE{ |
| sn-FieldLength | SN-FieldLengthUM |

OPTIONAL, --Cond Reestab

| | |
|---|---|
| t-Reassembly | T-Reassembly |
| } | |
| T-PollRetransmit ::= | ENUMERATED { |
| | ms5, ms10, ms15, ms20, ms25, ms30, ms35 |
| | ms40, ms45, ms50, ms55, ms60, ms65, ms70, |
| | ms75, ms80, ms85, ms90, ms95, ms100, ms105 |
| | ms110, ms115, ms120, ms125, ms130, ms135 |
| | ms140, ms145, ms150, ms155, ms160, ms165 |
| | ms170, ms175, ms180, ms185, ms190, ms195, |
| | ms200, ms205, ms210, ms215, ms220, ms225 |
| | ms230, ms235, ms240, ms245, ms250, ms300, |
| | ms350, ms400, ms450, ms500, ms800, ms1000, |
| | ms2000, ms4000, ms1-v1610, ms2-v1610, ms3-v1610 |
| | ms4-v1610, spare1} |
| PollPDU ::= | ENUMERATED { |
| | p4, p8, p16, p32, p64, p128, p256, p512, p1024, p2048, p4096, p6144, p8192, |
| p12288, p16384,p20480 | |
| | p24576, p28672, p32768, p40960, p49152, p57344, p65536, infinity, spare8 |
| spare7, spare6, spare5, | spare4, |
| | spare3, spare2, spare1} |
| PollByte ::= | ENUMERATED { |
| | kB1, kB2, KB5, kB8, kB10, kB15, kB25, kB50, kB75, |
| | kB100, kB125, kB250, kB375, kB500, kB750, kB1000, |
| | kB1250, kB1500, kB2000, kB3000, kB4000, kB4500, |
| | kB5000, kB5500, kB6000, kB6500, kB7000, kB7500 |
| | mB8, mB9, mB10, mB11, mB12, mB13, mB14, mB15 |
| | mB16, mB17, mB18, mB20, mB25, mB30, mB40, infinity, |
| | spare20, spare19, spare18, spare17, spare 16, |
| | spare15, spare14, spare13, spare12, spare11, |
| | spare10, spare9, spare8, spare7, spare6, spare5, |
| | spare4, spare3, spare2, spare1} |
| T-Reassembly ::= | ENUMERATED { |
| | ms0, ms5, ms10, ms15, ms20, ms25, ms30, ms35, |
| | ms40, ms45, ms50, ms55, ms60, ms65, ms70, |
| | ms75, ms80, ms85, ms90, ms95, ms100, ms110, |
| | ms120, ms130, ms140, ms150, ms160, ms170, |
| | ms180, ms190, ms200, spare1} |
| T-StatusProhibit ::= | ENUMERATED { |
| | ms0, ms5, ms10, ms15, ms20, ms25, ms30, ms35, |
| | ms40, ms45, ms50, ms55, ms60, ms65, ms70 |
| | ms75, ms80, ms85, ms90, ms95, ms100, ms105, |
| | ms110, ms115, ms120, ms125, ms130, ms135 |
| | ms 140, ms145, ms150, ms155, ms160, ms165 |
| | ms170, ms175, ms180, ms185, ms190, ms195, |
| | ms200, ms205, ms210, ms215, ms220, ms225, |
| | ms230, ms235, ms240, ms245, ms250, ms300 |
| | ms350, ms400, ms450, ms500, ms800, ms 1000 |
| | ms1200, ms1600, ms2000, ms2400, spare2, spare1} |
| SN-FieldLengthUM := | ENUMERATED{size6, size12} |
| SN-FieldLengthAM := | ENUMERATED{size 12, size18} |
| RLC-Config-v1610 ::= | SEQWTRUNCE{ |
| dl-AM-RLC-v1610 | DL-AM-RLC-v1610 |
| } | |
| DL-AM-RLC-v1610 := | SEQWTRUNCE{ |
| t-StatusProhibit-v1610 | T-StatusProhibit-v1610 |
| OPTIONAL, --Need N | |
| ... | |
| } | |
| T-StatusProhibit-v1610 ::= | ENUMERATED {ms1, ms2, ms3, ms4, spare4, spare3, spare2, spare1} |
| RLC-Config-v17xx ::= | SEQWTRUNCE{ |
| dl-UM-RLC-v17xx | DL-UM-RLC-v17xx |
| } | |
| DL-UM-RLC-v17xx ::= | SEQWTRUNCE{ |
| initial-SN | INTEGER (0 .. 65535) OPTIONAL, --Need N |
| ... | |
| } | |

--TAG-RLC-CONFIG-STOP

--ASN1STOP

In some examples, a WTRU may switch to a PTP mode, for example, in response to receiving an RRC reconfiguration message.

In some examples, a WTRU may receive an MBS configuration (e.g., an explicit MBS configuration), which may be associated with a target cell during a mobility event. For example, the MBS configuration may be associated with one or more of an RRC reconfiguration with synchronization, a conditional RRC reconfiguration, etc. For example, a WTRU may be configured with an MBS mode of the target cell that may be different from the source cell. The WTRU may perform one or more actions (e.g., as described herein), for example, based on the MBS mode configuration of the target cell in relation to the source cell.

A WTRU may be configured with behavior(s)/action(s) (e.g., additional behavior(s)/action(s)), for example, based on a relationship between the MBS mode configuration in the source and the MBS mode configuration in the target (e.g., as one is compared to the other). A WTRU may be configured to transmit a PDCP status report to the target, for example, in the case of switching from a PTM mode in source to a PTP mode in the target. A WTRU may be configured to transmit a PDCP status report to the target, for example, if configured with a PTP mode in the target (e.g., irrespective of the MBS mode in the source). A WTRU may be configured to transmit an indication of MBS mode switch to the target, for example, based on one or more conditions for an MBS mode switch (e.g., as described herein).

Explicit switching via a MAC control element may be provided (e.g., configured, implemented, performed). In some examples, the network may send a MAC CE to the WTRU, for example, if the network determines to indicate to the WTRU (e.g., wants the WTRU) to switch the MBS operation from a PTP mode to a PTM mode. A MAC CE configuration may include one or more of the following: information about which MRB the MAC CE refers to (e.g., a bearer ID, a logical channel ID, a G-RNTI, etc.); or information about an SN to be used to initialize the PTM RLC state variables.

In some examples, the MAC CE may include information about one or more (e.g., multiple, several) MRBs (e.g., a list including information, e.g., as described herein, for each of multiple MRBs).

In some examples, the MAC CE may include an identity associated with a MBS service/session. For example, the MAC CE may include a temporary mobile group identity (TMGI) associated with the MBS service. For example, the MAC CE may include a G-RNTI associated with the MBS service.

In some examples, a MAC CE without information about an MRB may be considered (e.g., interpreted) as an indication that the information is applicable to multiple MRBs (e.g., all MRBs) and/or MBS services (all MBS services).

Explicit switching via a DCI may be provided (e.g., configured, implemented, performed). In some examples, the network may send a DCI to the WTRU, for example, if the network determines to indicate to the WTRU (e.g, wants the WTRU) to switch the MBS operation from a PTP mode to a PTM mode. The DCI configuration may include one or more of the following: information about which MRB the DCI refers to (e.g., a bearer ID, a logical channel ID, a G-RNTI, etc.); or information about an SN to be used to initialize the PTM RLC state variables. The information about which MRB the DCI referring to may be implicit or explicit. For example, in the case of the implicit information, reception of the DCI in a PDCCH transmission may be associated with a G-RNTI and the associated G-RNTI may identify the associated MRB(s).

PDCCH transmission monitoring behavior on an MBS mode switch may be provided (e.g., configured, implemented, performed). In some examples, the WTRU may start monitoring for transmission(s) in a PDCCH for the C-RNTI, for example, in response to reception of a mode switch command indicating a switch from PTM to PTP (e.g., according to a method described herein, such as an RRC reconfiguration message, a MAC CE, a DCI, etc.) or in response to sending an MBS mode switch request indicating a request to switch from PTM to PTP.

The WTRU may apply a control resource set (CORESET) and/or a search space configuration associated with the C-RNTI (e.g., if configured).

In some examples, the WTRU may stop monitoring for transmission(s) in the PDCCH for the G-RNTI associated with the MRB(s), for example, in response to reception of a mode switch command indicating a switch from PTM to PTP (e.g., according to a method described herein, such as an RRC reconfiguration message, MAC CE, DCI, etc.) or in response to sending an MBS mode switch request indicating a request to switch from PTM to PTP.

In some examples, the WTRU may start monitoring for transmission(s) in the PDCCH for the G-RNTI associated with the MRB(s), for example, in response to reception of a mode switch command indicating a switch from PTP to PTM (e.g., according to a method described herein, such as an RRC reconfiguration message, MAC CE, DCI, etc.) or in response to sending an MBS mode switch request indicating a request to switch from PTP to PTM.

The WTRU may apply a CORESET and/or search space configuration information associated with the G-RNTI (e.g., if configured). The WTRU may (e.g., otherwise) monitor for transmission(s) in the PDCCH for the G-RNTI in the CORESET and/or search space configuration information associated with C-RNTI.

In some examples, the WTRU may stop monitoring for transmission(s) in the PDCCH for the C-RNTI, for example, in response to reception of a mode switch command indicating a switch from PTP to PTM (e.g., according to a method described herein, such as an RRC reconfiguration message, MAC CE, DCI, etc.) or in response to sending an MBS mode switch request indicating a request to switch from PTP to PTM.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-12. (canceled)

13. A wireless transmit-receive unit (WTRU), the WTRU comprising:
a processor configured to:
receive an indication to switch from a first transmission mode to a second transmission mode or determine to switch from the first transmission mode to the second transmission mode based on a reliability condition associated with the second transmission mode;
based on the indication or the determination, switch from the first transmission mode to the second transmission mode;
receive a first data packet; and
extend a data packet reception window by extending a boundary of the data packet reception window, wherein the boundary is extended based on a sequence number (SN) of the first data packet and an offset.

14. The WTRU of claim 13, wherein the processor is further configured to:
receive a second data packet; and
add the second data packet to a reception buffer for processing, wherein the addition is based on a SN of the second data packet being within an extended part of the extended data packet reception window.

15. The WTRU of claim 14, wherein the boundary of the data packet reception window is a starting edge of the data packet reception window, and wherein extending the boundary of the data packet reception window comprises setting a first value of the starting edge to a second value that is lower than the SN of the first data packet by the offset.

16. The WTRU of claim 15, wherein the extended part of the extended data packet reception window is a part of the extended data packet reception window that starts at the second value and ends at the SN of the first data packet.

17. The WTRU of claim 13, wherein the indication is based on a network command in configuration information received from a network, and wherein the configuration information is radio resource control (RRC) configuration information, medium-access control (MAC) control element information, or downlink control information (DCI).

18. The WTRU of claim 13, wherein the first transmission mode is a point-to-point (PTP) transmission mode and the second transmission mode is a point-to-multipoint (PTM) transmission mode.

19. The WTRU of claim 18, wherein the indication is based on reception of a radio link control (RLC) data packet via an RLC entity associated with the PTM transmission mode, and wherein the WTRU is operating in the PTP transmission mode.

20. A method performed by a wireless transmit-receive unit (WTRU), the method comprising:
receiving an indication to switch from a first transmission mode to a second transmission mode or determine to switch from the first transmission mode to the second transmission mode based on a reliability condition associated with the second transmission mode;
based on the indication or the determination, switching from the first transmission mode to the second transmission mode;
receiving a first data packet; and
extending a data packet reception window by extending a boundary of the data packet reception window, wherein the boundary is extended based on a sequence number (SN) of the first data packet and an offset.

21. The method of claim 20, the method further comprising:
receiving a second data packet; and
adding the second data packet to a reception buffer for processing, wherein the addition is based on a SN of the second data packet being within an extended part of the extended data packet reception window.

22. The method of claim 21, wherein the boundary of the data packet reception window is a starting edge of the data packet reception window, and wherein extending the boundary of the data packet reception window comprises setting a first value of the starting edge to a second value that is lower than the SN of the first data packet by the offset.

23. The method of claim 22, wherein the extended part of the extended data packet reception window is a part of the extended data packet reception window that starts at the second value and ends at the SN of the first data packet.

24. The method of claim 20, wherein the indication is based on a network command in configuration information received from a network, and wherein the configuration information is radio resource control (RRC) configuration information, medium-access control (MAC) control element information, or downlink control information (DCI).

25. The method of claim 20, wherein the first transmission mode is a point-to-point (PTP) transmission mode and the second transmission mode is a point-to-multipoint (PTM) transmission mode.

26. The method of claim 25, wherein the indication is based on receiving a radio link control (RLC) data packet via an RLC entity associated with the PTM transmission mode, and wherein the WTRU is operating in the PTP transmission mode.
